(19) United States
(12) Patent Application Publication
(10) Pub. No.: US 2024/0416295 A1
(43) Pub. Date: Dec. 19, 2024

(54) CARBONATION CHAMBER

(71) Applicant: SharkNinja Operating LLC, Needham, MA (US)

(72) Inventors: Tie He Yang, Shenzhen (CN); Jack Richardson, Yorkshire (GB); Christopher Meyer-Rassow, London (GB)

(21) Appl. No.: 18/434,482

(22) Filed: Feb. 6, 2024

Related U.S. Application Data
(62) Division of application No. 18/354,376, filed on Jul. 18, 2023, now Pat. No. 11,931,704.
Application No. 18/354,376 is a continuation of application No. PCT/CN2023/100706, filed on Jun. 16, 2023.

(51) Int. Cl. B01F 23/236; A23L 2/54; B01F 23/237; B01F 33/453; B01F 101/14; B67D 1/00

(52) U.S. Cl. CPC B01F 23/2363; A23L 2/54; B01F 23/237621; B01F 33/453; B67D 1/007; B67D 1/0071; B01F 2101/14

(57) ABSTRACT

A mixing chamber for use in a beverage carbonation system is provided. In one embodiment, the mixing chamber includes a housing, an agitator, a motor assembly and a rigid plate. A housing of the agitator and a housing of the motor assembly can each include a set of magnetics disposed therein and magnetically coupled so as to provide magnetic coupling between the motor assembly and the agitator. The mixing chamber is configured to receive a gas, such as carbon dioxide, and a liquid, such as water, to form a carbonated fluid. The carbonated fluid can be dispensed from the beverage carbonation system as a beverage.

### CROSS-REFERENCE TO RELATED APPLICATIONS

This application is a divisional of U.S. application Ser. No. 18/354,376, filed on Jul. 18, 2023, entitled “CARBONATION CHAMBER,” which is a continuation application which claims the benefit of Application No. PCT/CN2023/100706, filed on Jun. 16, 2023, entitled “CARBONATION CHAMBER,” each of which is hereby incorporated by reference in its entirety.

### TECHNICAL FIELD

A carbonation chamber for use in a beverage carbonation machine is provided.

### BACKGROUND

In food products such as soda, sparkling water, tea, juice, or coffee, carbon dioxide (CO2) or a combination of nitrogen and CO2 is typically used to create the bubbles that form and rise through the liquid. Several factors dictate the carbonation level of beverages, including sugar and alcohol; however, the most significant factors are CO2 pressure and temperature. The quantity of CO2 dissolved in a beverage can impact the flavor, mouthfeel, and palatability of the beverage.

Many existing carbonated beverage producers carbonate beverages in their manufacturing plants and then add carbonated beverages in appropriate pressure bottles, tanks or other containers to authorized distributors of carbonated beverages, retailers, grocery stores, etc. Commercial beverage carbonation usually involves mixing carbon-dioxide with liquid under pressure with intensive mixing. Such commercial methods, however, require elaborate and sophisticated equipment not available at the point of beverage consumption. Further, shipping and storage of pressurized bottles and containers increases costs.

Beverage carbonation machines suitable for home use have been developed, but typically utilize a specialized container to be attached to the device. The container is pre-filled with liquid and is pressurized with carbon dioxide injected into the liquid. One common complaint of people who use home seltzer machines is that the sodas these machines produce are not as bubbly as store-bought versions. Another common complaint is that beverage carbonation machines suitable for home use may require a user to carbonate the full container at a time, unless they are willing to accept a significant reduction in carbon dioxide efficiency from their container.

Accordingly, there remains a need for improved methods and devices for carbonating a liquid.

### SUMMARY

Carbonation chambers for use in carbonating a liquid are provided.

In one embodiment, a carbonation mixing chamber is provided having a housing, an agitator, a motor assembly, and a rigid plate. The housing can have an inner chamber with a fluid inlet configured to receive fluid from a fluid source, a gas inlet configured to receive gas from a gas source, and an outlet configured to dispense a mixture of fluid and gas. The agitator can be disposed within the housing and can have an elongate shaft with a plurality of arms extending radially outward from the elongate shaft. The agitator can also have an agitator coupling housing at a terminal end of the elongate shaft and having a first set of magnets disposed therein. The motor assembly can be disposed external to the housing and can have a motor coupling housing with a second set of magnets disposed therein and positioned in magnetic engagement with the first set of magnets. The motor assembly can also include a drive shaft coupled to the motor coupling housing, and a motor coupled to the drive shaft and configured to rotate the drive shaft and the motor coupling housing such that the second set of magnets cause corresponding rotation of the first set of magnets to thereby rotate the agitator. The rigid plate can form a portion of an outer wall of the housing and can be positioned between the agitator coupling housing and the motor coupling housing.

One or more of the following features can be included in any feasible combination. For example, the housing can be formed from plastic, and the rigid plate can be formed from metal. The housing can include an upper portion and a lower portion mated to one another to define the inner chamber therein, and the agitator coupling housing can be positioned on a bottom wall of the lower portion of the housing. In certain embodiments, the housing can include a sidewall with a minimum thickness that is greater than a maximum thickness of the rigid plate. In other aspects, the inner surface of the housing can include a plurality of ribs positioned radially around the inner chamber.

In another embodiment, the rigid plate can be mounted within a central opening in a wall of the housing, and a sealing gasket can be positioned between the rigid plate and the housing to form a seal there between. The rigid plate can form a portion of the bottom wall of the lower portion. In some embodiments, the rigid plate can include a central divot configured to receive a central nub on the terminal end of the elongate shaft. In other aspects, the rigid plate can be formed from a non-ferromagnetic metal.

In other aspects, one or more of the fluid inlet, gas inlet, and outlet can include a valve movable between open and closed positions, and the inner chamber can be configured to be fluidically sealed when the valves are in the closed position.

In another embodiment, a carbonation system is provided and can include a housing having a fluid reservoir configured to hold a volume of fluid, a mixing chamber housing configured to receive fluid from the fluid reservoir and gas from a gas source and to mix the fluid and gas to form a carbonated beverage, and a fluid outlet configured to dispense the carbonated beverage. The mixing chamber housing can include a plate mounted in a sidewall thereof and positioned between inner and outer magnetic drive housings. The outer magnetic drive housing can be coupled to a motor configured to rotate the outer magnetic drive housing to cause corresponding rotation of the inner magnetic drive housing, and the inner magnetic drive housing can be coupled to an agitator blade configured to agitate fluid and gas in the mixing chamber housing.

One or more of the following features can be included in any feasible combination. For example, the mixing chamber housing can be formed from plastic and the plate can be formed from metal.

In one example, the mixing chamber housing can include an outer sidewall with a minimum wall thickness that is greater than a maximum thickness of the plate. The mixing chamber housing can include a domed upper portion and a cup-shaped lower portion mated to one another.

In another example, the inner magnetic drive housing can include a first set of magnets disposed therein and magnetically coupled to a second set of magnets disposed within the outer magnetic drive housing. Further, the inner magnetic drive housing and agitator blade can be mounted on a central shaft having a terminal end freely movably positioned within a divot formed in the plate.

In another embodiment, a method for mixing fluid and gas is provided. The method can include the steps of activating a motor to rotate an outer magnetic drive housing and thereby cause corresponding rotation of an inner magnetic drive housing disposed within a mixing chamber and positioned on an opposite side of a separation plate from the outer magnetic drive housing, the mixing chamber being fluidically sealed and having a fluid and a gas disposed therein, and rotation of the inner magnetic drive housing rotating an agitator coupled thereto to thereby mix the fluid and gas.

One or more of the following features can be included in any feasible combination. For example, the agitator can include a plurality of arms extending radially outward from a central shaft, a terminal end of the central shaft being freely movably positioned within a divot formed in the separation plate.

In another example, prior to mixing, the gas can be located above the liquid within the mixing chamber, and during rotation of the agitator the gas can flow into an upper opening in an elongate shaft of the agitator and out of a lower opening of the elongate shaft of the agitator.

In yet another example, the mixing chamber can be disposed within a beverage dispensing system, and the method include the step of dispensing the mixed fluid and gas into a container.

### DESCRIPTION OF DRAWINGS

These and other features will be more readily understood from the following detailed description taken in conjunction with the accompanying drawings, in which:

FIG. 1 is a front view of one embodiment of a beverage dispensing system;

FIG. 2 is a rear perspective view of the beverage dispensing system of FIG. 1 with various housing components removed;

FIG. 3 is a first perspective view of one embodiment of a carbonation mixing chamber for use with a beverage dispensing system;

FIG. 4 is another perspective view of the carbonation mixing chamber of FIG. 3;

FIG. 5 is another perspective view of the carbonation mixing chamber of FIG. 3;

FIG. 6 is a side perspective view of an upper portion of a housing of the carbonation mixing chamber of FIG. 3;

FIG. 7 is a bottom perspective view of an upper portion of a housing of the carbonation mixing chamber of FIG. 3;

FIG. 8 is a top perspective view of a lower portion of a housing for the carbonation mixing chamber of FIG. 3;

FIG. 9 is a side perspective view of one embodiment of an agitator for use with the carbonation mixing chamber of FIG. 3;

FIG. 10 is a top perspective view of the agitator of FIG. 9 for use with the carbonation mixing chamber of FIG. 3;

FIG. 11 is a side perspective view of one embodiment of an agitator coupling housing for use with the carbonation mixing chamber of FIG. 3;

FIG. 12 is a side perspective view of one embodiment of a rigid plate for use with the carbonation mixing chamber of FIG. 3;

FIG. 13 is an exploded side perspective view of one embodiment of a motor assembly for use with the carbonation mixing chamber of FIG. 3;

FIG. 14 is a side cross-sectional view of the carbonation mixing chamber of FIG. 3; and

FIG. 15 is a flow-chart showing one embodiment of a process for using a carbonation mixing chamber.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain illustrative embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting illustrative embodiments and that the scope of the present invention is defined solely by the claims. The features illustrated or described in connection with one illustrative embodiment can be combined with the features of other embodiments. Such modifications and variations are intended to be included within the scope of the present invention.

Further, in the present disclosure, like-named components of the embodiments generally have similar features, and thus within a particular embodiment each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape.

In general, a carbonation mixing chamber for use with a carbonation system is provided. In some embodiments, the carbonation mixing chamber includes a housing, an agitator, a motor assembly, and a rigid plate. In general, the agitator (also referred to herein as an “impeller”) is configured to rotate in the mixing chamber to mix together a gas, such as carbon dioxide (CO2), and a liquid, such as water, to form a carbonated fluid. The agitator can include an agitator coupling housing at a terminal end of an elongate shaft and having a first set of magnets disposed therein. The motor assembly can be disposed external to the housing and can have a motor coupling housing with a second set of magnets disposed therein and positioned in magnetic engagement with the first set of magnets. The motor assembly can also include a drive shaft coupled to the motor coupling housing, and a motor coupled to the drive shaft and configured to rotate the drive shaft and the motor coupling housing such that the second set of magnets cause corresponding rotation of the first set of magnets to thereby rotate the agitator. The rigid plate can form a portion of an outer wall of the housing and can be positioned between the agitator coupling housing and the motor coupling housing. The magnetic coupling between the first set of magnets in the agitator housing and the second set of magnets in the motor coupling housing allows for the fast movement of the agitator within the carbonation mixing chamber thereby allowing for the fast diffusion of a gas within a liquid.

The mixing of liquids and gasses within the carbonation mixing chamber requires high pressure. The high pressure within the chamber and the pressure differential between the interior of the chamber and the environment can cause damage to physical couplings utilized between the agitator and the motor. Accordingly, in the disclosed embodiments, the agitator housing and the motor coupling housing utilize a magnetic coupling, which does not require the presence of a physical coupling such as a combination of reciprocal holes and steel rods that are positioned to rotatably link the motor and agitator. In order to transmit magnetic forces across a wall of the housing, the wall must be relatively thin. A thin wall, especially one formed from plastic, however, may not withstand the high pressures required in a carbonation system. Accordingly, the disclosed systems can include a thin rigid plate, such as metal plate, which forms a portion of an outer wall of the housing and can be positioned between the agitator coupling housing and the motor coupling housing. The rigid plate can provide an interface between the magnetic couplings that avoids a rapid drop in magnetic force, while withstanding high pressures. The modified carbonation system can thus achieve the various benefits described herein.

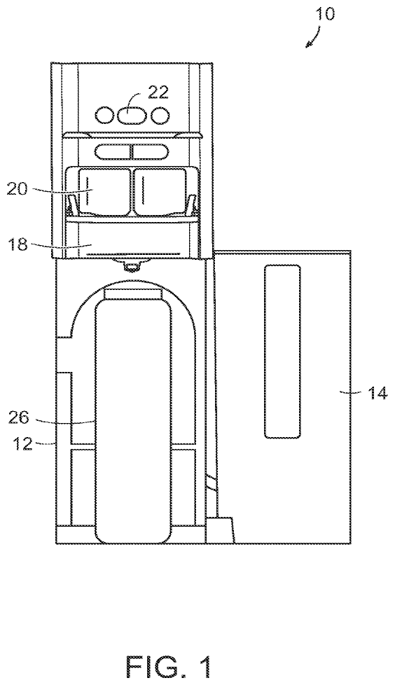

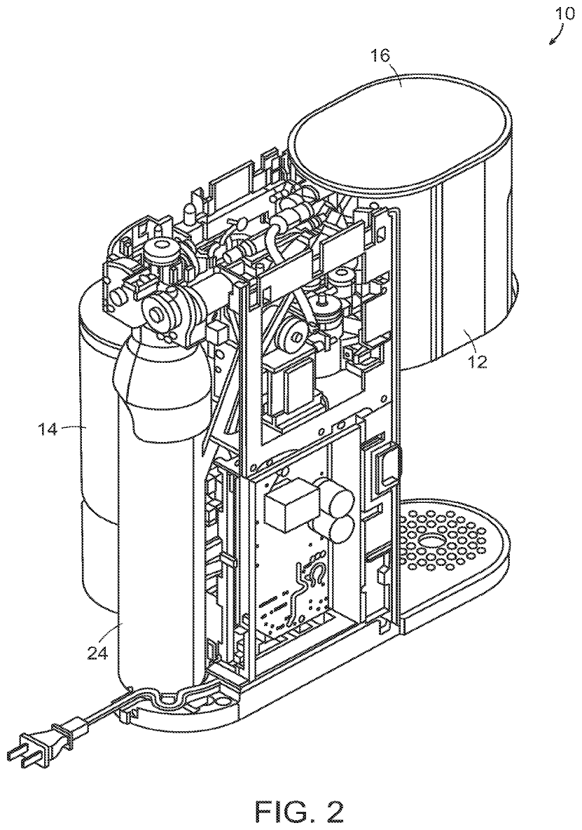

FIGS. 1-2 illustrate a beverage dispensing system 10 according to one embodiment. The beverage dispensing system 10 can be used to create and dispense customized beverages for a user, based on desired characteristics of the beverage. The illustrated beverage dispensing system 10 generally includes a housing 12 having a fluid reservoir 14 and a carbonation assembly 16. In the illustrated system 10, a carriage assembly 18 is included for receiving one or more ingredient containers 20 to be used in the creation of beverages. The ingredient containers 20 can include one or more additives (e.g., a flavorant, a vitamin, a food dye, etc.) to be included in a created beverage as desired. However, a person skilled in the art will appreciate that the mixing chamber disclosed herein can be used in any beverage dispensing system, including those that lack an ingredient container. Other beverage dispensing systems include, by way of non-limiting example, coffee, tea, beer, juice, and similar beverage-making apparatus.

During a beverage dispensing process, a user can actuate inputs located at a user interface 22 in order to select specific characteristics of the desired beverage, such as fluid volume and carbonation level. If the user selects inputs to indicate that the beverage is carbonated, water can be fed from the fluid reservoir 14 and into the carbonation assembly 16, and carbon-dioxide can be fed from a canister 24 and into the carbonation assembly 16 to produce carbonated water. The beverage can be dispensed into a container, such as a drinking glass 26.

Examples of beverage dispensing systems compatible with the carbonation mixing chamber provided herein can be found in U.S. patent application Ser. No. 17/989,640, entitled “INGREDIENT CONTAINERS FOR USE WITH BEVERAGE DISPENSERS” filed on Nov. 17, 2022, and U.S. patent application Ser. No. 17/744,459, entitled “FLAVORED BEVERAGE CARBONATION SYSTEM” filed on Can 13, 2022, the contents of both of which are hereby incorporated by reference in their entirety.

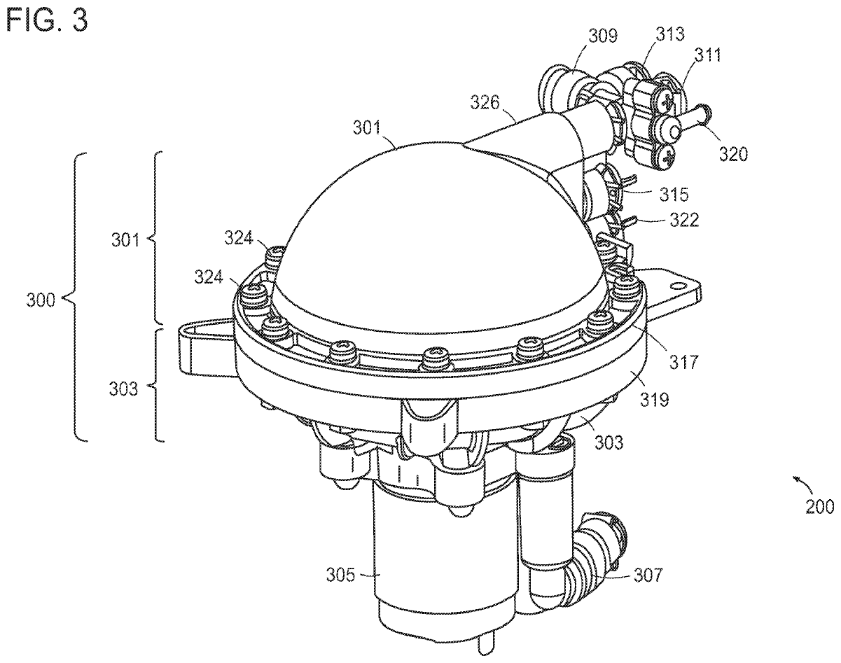

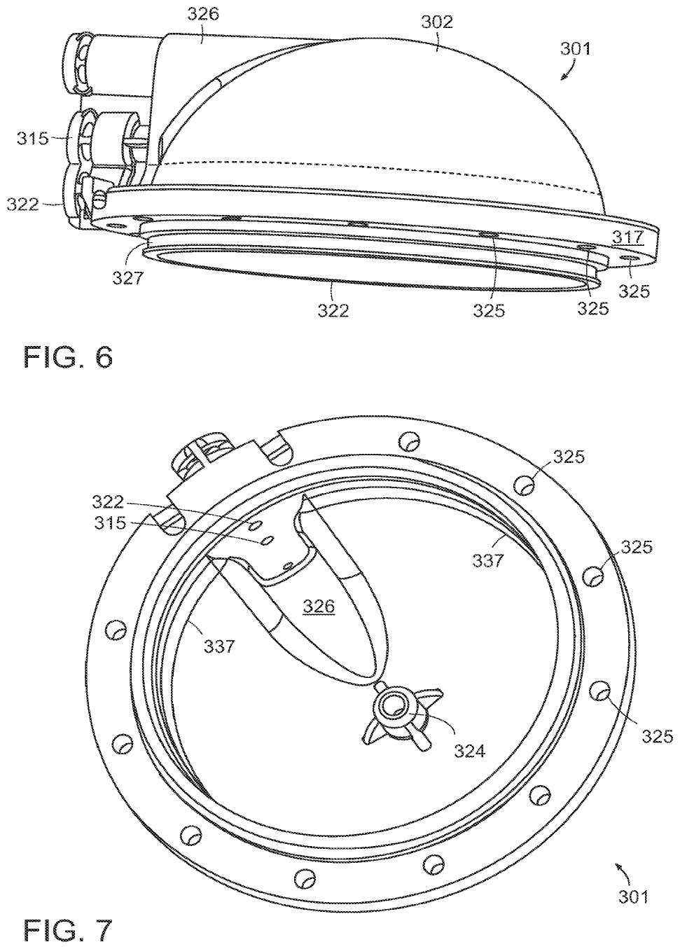

FIGS. 3-14 illustrate one embodiment of a carbonation mixing chamber 200 for use with a carbonation system, such as the system 10 shown in FIGS. 1-2. The carbonation illustrated mixing chamber includes a housing 300, an agitator 400, a motor assembly 600, and a rigid plate 500, each of which is described in more detail below.

The housing 300 can have a variety of configurations and can have various shapes and sizes. While the particular configuration can vary depending on the beverage system configured to contain the housing 300, in the illustrated embodiment the housing 300 includes an upper portion 301 and a lower portion 303 that mate to define an inner chamber 202 therein. As shown, the upper portion 301 can have a substantially domed hemispheric shape, and can include projections on one side 326 containing one or more fluid inlets, sensors, gas inlets, and valves. The upper portion 301 can also include a flat face 304 at the terminal edge thereof, with a ridge 327 projecting from the flat face 304. The ridge 327 can be substantial circumferential and it can be configured to receive an o-ring 328 to aid in forming a seal with the lower portion 303. The flat face of the hemispheric shape can also include a protruding flange 317 containing one or more holes 325 configured to receive one or more screws 321. The lower portion 303 can be similarly hemi-spherical or cup-shaped, however it can have a height that is less than a height of the upper portion 301. Further, the bottom wall of the lower portion 303 can have an enlarged, substantially circular opening 339 formed therein. The opening 339 can be configured to be filled by the rigid plate 500, as discussed below. The lower portion 303 can also include a flattened rim 329 at the terminal end thereof. The rim 329 can have a circumferential channel 331 configured to receive the ridge 327 on the upper portion 301. The lower portion 303 can also include a plurality of holes 333 in the rim 329 that are configured to align with the holes 325 in the upper portion 301 and to receive screws 321 there through for mating the upper and lower portions 301, 303. In some embodiments, the holes 325 and 333 can be threaded. When mated, the o-ring is compressed thereby forming a fluid-tight seal between the upper and lower portions 301, 303 to create a sealed chamber therein.

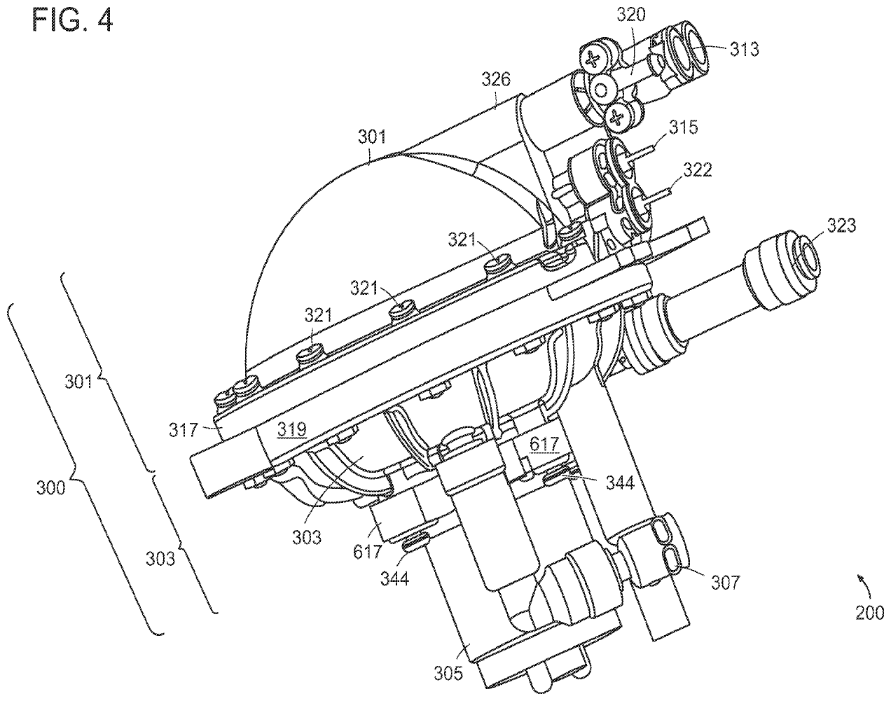

The inner chamber 202 or fluid reservoir in the housing 300 is configured to receive gas and fluid. The inner chamber 202 is further configured to hold a volume of gas, fluid, or a carbonated liquid. The inner chamber 202 can be connected to one or more fluid inlets 323 configured to receive fluid from a fluid reservoir. As best shown in FIG. 4, the fluid inlet 323 is in the form of a tubular structure projecting from a sidewall of the lower portion 303 of the housing. Fluid received in the inner chamber 202 from the fluid reservoir can be mediated by a flow meter that is configured to regulate the amount of liquid that flows from the fluid reservoir to the inner chamber 202. The flow meter can regulate a pump, such as a high pressure pump that is configured to pump fluid from the fluid reservoir to the inner chamber 202. Liquids can include water, juice, coffee, and the like. The flow meter can be controlled by a micro controller unit that is communicatively coupled to sensors. The fluid inlet 323 can in some embodiments be configured to receive water or other flavorings.

The inner chamber 202 can also be connected to one or more gas inlets 309 configured to receive gas from a gas source. The gas source is configured to be a source of gas for mixing in the inner chamber 202. The transfer of gas from the gas source to the inner chamber 202 can be mediated by a gas regulator that is configured to regulate the amount of gas that flows from the gas source to the inner chamber 202 and a gas solenoid valve that is configured to open and close selectively to allow the gas to flow from the gas source to the inner chamber 202. In the illustrated embodiment, the gas is CO2 and the gas source can be a CO2 cylinder. However, it is contemplated that another gas can be used (in which case the resulting fluid of the mixing operation would not be a “carbonated” fluid but would be a treated fluid). As best shown in FIGS. 3, 5 and 12, the gas inlet 309 is positioned along the top of the domed hemisphere of the upper portion 301 of the housing 300. Such a configuration allows the gas to be delivered above a fluid level within the chamber.

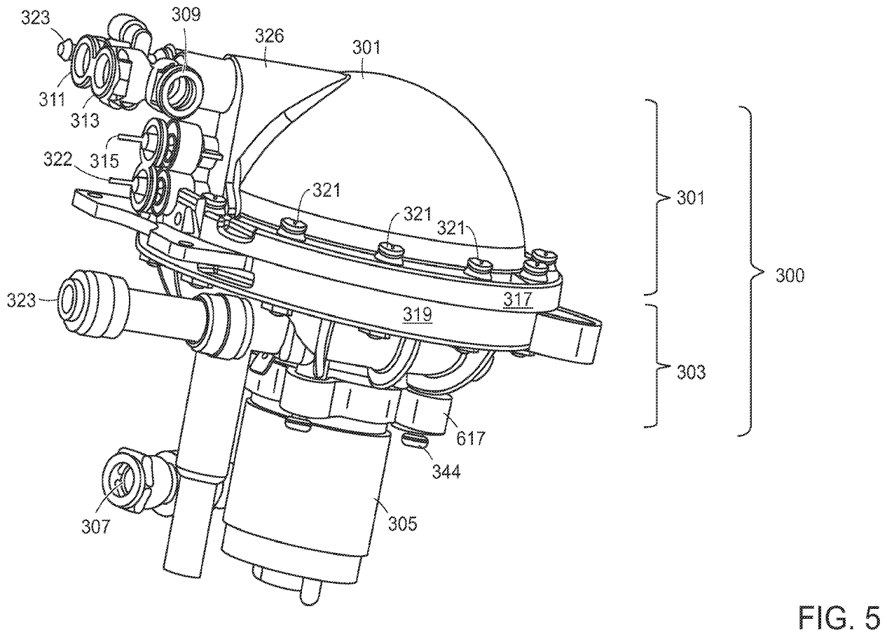

The inner chamber 202 can also be connected to a fluid outlet 307 that is configured to dispense the carbonated or treated beverage, which is a mixture of liquid and gas. As best shown in FIGS. 4-5, in the illustrated embodiment the fluid outlet 307 is a tubular member projecting downward from a bottom wall of the lower portion 303 of the housing 300. Such a configuration allows the fluid to fully drain out of the chamber. However, in some embodiments, the carbonation system 10 can include an air pump configured to drive the treated or carbonated fluid out of the inner chamber 202 through the fluid outlet 307. The treated or carbonated fluid can be dispensed directly or indirectly into a container, such as a cup, a bottle, and the like.

As further shown in FIGS. 3-7, and 12, the upper portion 301 can include a lower water sensor 322 positioned along the side with projections thereon 326. The lower water sensor 322 can be embedded within the domed hemisphere of the upper portion 301. The lower water sensor can include a conductive probe that is configured to send a signal when the fluid level in the inner chamber 202 has reached the lower water sensor 322. The conductive probe can be configured to send the signal to a micro controller unit which can be communicatively coupled to a flow meter or other component that is configured to mediate the flow of water into the inner chamber 202. For example, the signal received at the micro controller unit from the conductive probe can cue the communicatively coupled flow meter to stop the flow of water into the inner chamber 202 in a set amount of time. For example, the signal can span 2 seconds, or any other set amount of time depending upon the spacing between the lower water sensor 322 and the upper water sensor 315.

The upper portion 301 can also include an upper water sensor 315. As illustrated in FIGS. 3-7, and 12, the upper water sensor 315 can be positioned along the side of the upper portion 301 having projections thereon 326, and be positioned substantially above the lower water sensor 322. The upper water sensor 315 can be a conductive probe configured to send a signal to a microcontroller unit. For example, as discussed above, the conductive probe associated with the upper water sensor 315 can also be configured to send the signal to a micro controller unit which can the same or different to the micro controller unit discussed above. The micro controller unit can be communicatively coupled to a flow meter or other component that is configured to mediate the flow of water into the inner chamber 202. For example, the signal received at the micro controller unit from the conductive probe of the upper water sensor 315 can cue the communicatively coupled flow meter to stop the flow of water into the inner chamber 202. The upper water sensor 315 can be configured to send a signal to the gas regulator to fill the inner chamber 202 with gas.

In other embodiments, additional valves can be connected to the housing 300. For example, additional valves can be connected to the upper portion 301 of the housing 300 via one or more ports. These additional valves can include a vent solenoid valve connected to a port 313 and configured to vent pressure from the inner chamber 202 at a predefined rate. This may provide an advantage over conventional systems which may be configured to vent pressure all at once. Advantageously, in an exemplary embodiment, the bleeding off of pressure at a defined rate may prevent carbonation loss within the inner chamber 202 such that the carbonated beverage is produced at a better quality. One or more pressure sensors can be connected to the inner chamber 202 and can be configured to control the operation of the vent solenoid valve of port 313. The vent solenoid valve of port 313 can be configured to expel a set amount of pressure when the valve is opened. The vent solenoid valve of port 313 can include a solenoid vent configured to be repeatedly opened and closed to release pressure as needed in a slow release.

In other aspects, a burst disk valve 320 can be connected to the upper portion 301 of the housing 300. The burst disk valve 320 can be configured to seal the inner chamber 202. However, when a set amount of pressure is reached in the inner chamber 202 the burst disk valve 320 can be configured to rupture or break or open, releasing the contents of the inner chamber 202. The operation of the burst disk valve 320 can be coupled to one or more sensors configured to sense the pressure in the inner chamber 202.

In other aspects, additional pressure release valves can be connected to the upper portion 301 of the housing 300 via a port to allow for fast diffusion of pressure from the inner chamber 202. For example, when pressure release valves can be configured to open so as to release the contents of the inner chamber 202 when the pressure measured in the inner chamber 202 exceeds a set threshold. For example, the upper portion 301 of the housing 300 can be connected to one, or two, or more pressure release valves, each of which can be configured to release pressure when the pressure inside of the inner chamber 202 or the pressure differential between the inner chamber 202 and the environment reaches the same or different thresholds.

Additional sensors can be embedded within the housing 300. Additional sensors can include a temperature sensor configured to measure temperature in the chamber, such as a negative temperature coefficient (NTC) thermistor, or the like.

Each of the fluid inlet, gas inlet, and fluid outlet can include a valve that is movable between open and closed positions. The inner chamber 202 can be configured to be fluidically sealed when the valves are in the closed position. Additionally, the inner chamber 202 can be configured to be hermetically sealed to prevent the flow of gas when the valves are in the closed position.

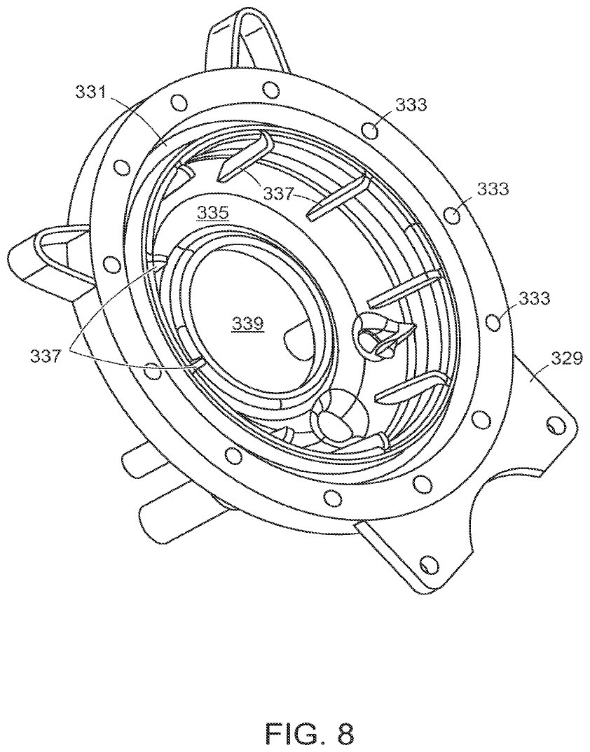

The inner chamber 202 can include a number of additional features to aid in mixing of a gas with a fluid. For example, the interior surface of the inner chamber 202 can have a plurality of ribs 337 that are positioned radially around the inner chamber 202. The ribs 337 can be integrally formed along the interior surface of the inner chamber 202 or alternatively, can be affixed thereto. As shown in FIG. 7, the ribs 337 can be dispersed along the interior surface of the upper portion 301 longitudinally. As shown in FIG. 8, the ribs 337 can also be dispersed along the inner surface 335 of the lower portion 303 latitudinally. The ribs 337 can have any suitable shape, including having a fin-like shape with one end of the rib having a shorter height than a second end of the rib with a curve therebetween. The ribs 337 can have a substantially rectangular shape with equal heights at a first end and a second end. The ribs 337 can be straight or curved. In some embodiments, the ribs can be formed of plastic. Each of the plurality of ribs can be identical, or can vary in size or shape. The ribs 337 can be oriented longitudinally, latitudinally, or any combination thereof. The ribs 337 can be configured to agitate the liquid and gas mixtures so as to improve carbonation by providing an additional surface area to the liquid, gas, or liquid and gas mixture. The ribs provide additional surface area and roughness to the smooth internal walls so as to prevent liquids from spinning against the internal walls and instead so that the liquids mix with the gas in the inner chamber 202. In other aspects, the interior surface of the inner chamber 202 can be formed from or coated with a hydrophilic material. The hydrophilic material can be configured to allow liquids contained within the inner chamber 202 to be in close proximity to the interior surface of the inner chamber 202, thus reducing the headspace or airgap within the inner chamber 202. This is advantageous as there is less space for a gas (i.e., CO2) to leave the liquid (i.e., H2O), thus providing improved carbonation. In some embodiments, the ribs 337 (discussed above) can also be coated or formed from a hydrophilic material.

The upper and lower portions 301, 303 of the housing 300 can be formed of a variety of materials, but in an exemplary embodiment the housing 300 is formed from any suitable plastic. This aids in reducing costs while providing a relatively light weight chamber. However, in order to withstand high pressure, e.g., up to 1.6 or 1.7 mega pascals, certain portions of the housing 300 can be relatively thick, e.g., in a range of about 10 to 12 mm. In some embodiments, the lower portion 303 can have a thickness that is greater than a thickness of the upper portion 301. For example, in some embodiments, the housing may have a nominal wall thickness of 3.5 mm and increase to approximately 6 mm in the thickest areas.

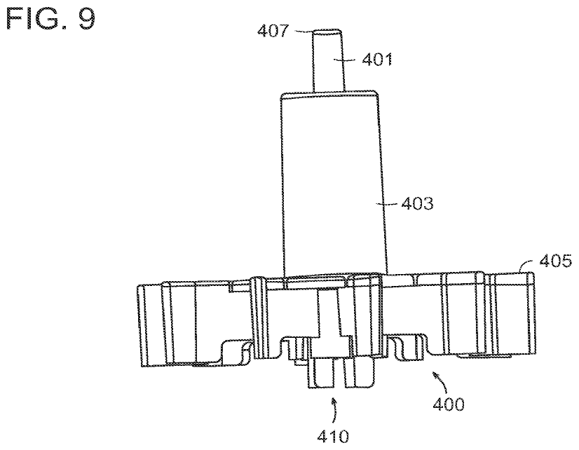

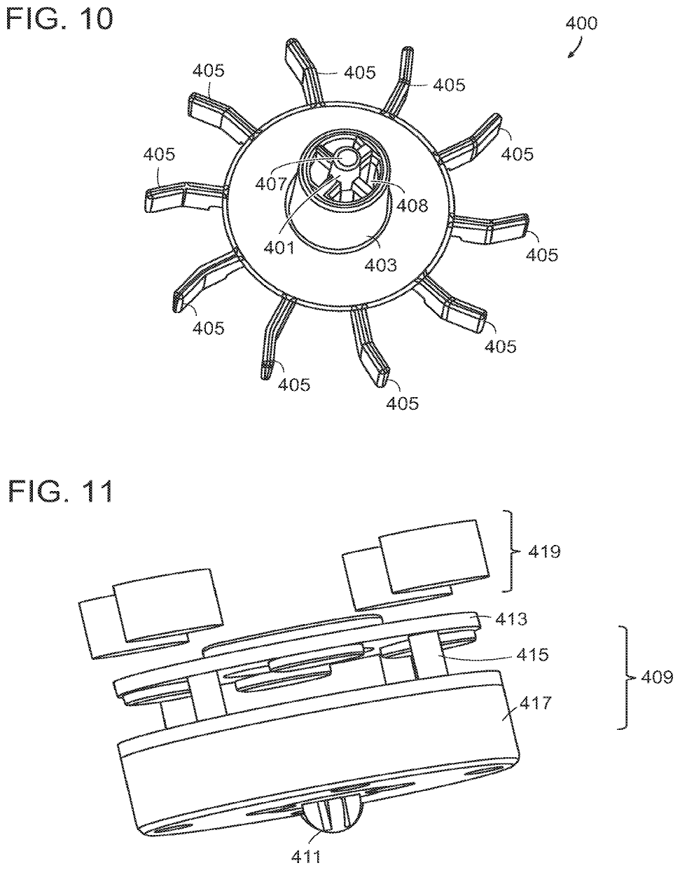

FIGS. 9-10 illustrate an exemplary agitator 400 configured to be disposed within a housing, such as housing 300. In the illustrated embodiment, the agitator 400 is the form of an impeller having an elongate shaft 401 with a top end 407 and a bottom end 410. The elongate shaft 401 can have an enlarged middle shaft 403 with a diameter larger than the diameter of the top end 407 of the elongate shaft 401. The interior of the middle shaft 403 provides an inner lumen for the elongate shaft. As shown in FIG. 9, there can be one or more recesses or openings 408 between the top end 407 of the elongate shaft 401 and the middle shaft 403. The openings 408 can be positioned to expose the inner lumen of the elongate shaft 401 to the outside of the elongate shaft 401. During operation of the carbonation mixing chamber, air and liquid can flow from the inner chamber 202, through the top opening 408 between the top end 407 of the elongate shaft 401 and the middle shaft 403, downwards through the lumen of the elongate shaft 401 towards the terminal end 410 of the elongate shaft towards one or more recesses. Recesses can be positioned proximate a plurality of arms 405 that extend from the elongate shaft 401.

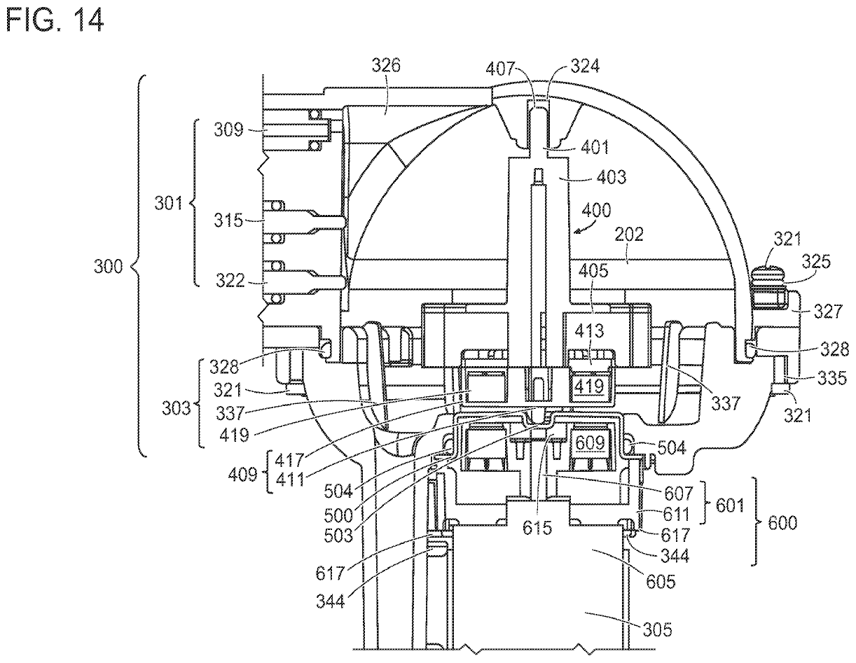

As illustrated in FIGS. 7 and 14, the top end 407 of the elongate shaft can be positioned in alignment or engaged with a housing 324 formed in or attached to a substantially central position on the inner surface of the upper portion 301.

As further shown, the elongate shaft 401 can have a plurality of blades or arms 405 extending radially outward therefrom. The arms 405 can be positioned proximate the terminal end of the elongate shaft 401. The agitator 400 can have any number of arms including 2, 3, 4, 5, 6, 8, etc. The arms 405 can be shaped to aid in pushing fluid in a circular pattern. As shown, the illustrated arms increase in size radially from the elongate shaft 401. The arms 405 can also be curved. The arms 405 can be spaced equidistantly around the elongate shaft 401 in the lower portion of the agitator. In other aspects, the arms 405 can have one or more holes or openings or be shaped to be hollow, so as to allow liquid and gas to flow through. All or certain portions of the arms 405 can be solid components configured to push liquid and gas or a combination thereof. In use, the arms 405 are configured to agitate the fluid and gas mixture, and thus can have various shapes to aid in doing so.

The agitator 400 can be mated to an agitator coupling housing 409 configured to magnetically couple with a motor coupling housing, discussed further below, in order to allow a rotational force to be transmitted to the agitator 400. The agitator coupling housing 409 can be positioned such that the arms 405 of the agitator 400 sit above the agitator coupling housing 409. The elongate shaft 401 can be fixedly mated to or integrally formed with the agitator coupling housing such that rotation of the agitator coupling housing causes corresponding rotation of the elongate shaft. The agitator coupling housing 409 can have a lower casing 417 and an upper plate 413. The upper plate 413 can include one or more locking elements 415 configured to engage with receiving elements positioned in the interior of the lower casing. The agitator coupling housing 409 can include one or more compartments for holding magnets 419. A first set of magnets 419 can be disposed within the agitator coupling housing 409. The first set of magnets 419 can include any suitable number of magnets, for example, 2, 3, 4, 5, 6, or more magnets. Compartments for holding magnets 419 can be in any suitable shape compatible with magnets. For example, the compartments can be square shaped, oval shaped, circular shaped and the like. The compartments can be spaced radially throughout the agitator coupling housing 409.

As further shown in FIG. 11, the agitator coupling housing 409 can include a nub 411 formed on a bottom surface of the casing 417. The illustrated nub 411 has a hemispherical shape, however it can have various shapes and sizes. The nub 411 can be integrally formed with the casing 417, or in other embodiments it can be formed from the terminal end of the elongate shaft 401 projecting through the casing 417. The nub 411 can be configured to engage with a divot formed in a separation plate, as discussed below. The nub can be free to float or move within the divot, so as to provide clearance for movement of the agitator 400.

As previously indicated, the carbonation mixing chamber can also include a rigid separation plate to provide an interface between the agitator coupling housing 409 and the motor coupling housing discussed further below. FIG. 12 illustrates one exemplary embodiment of a rigid separation plate 500. The illustrated plate 500 is substantially cylindrical with a flange 505 extending radially outward from a rim thereof. The plate has an upper surface 501 with a divot 503 positioned in the center. The divot 503 can be configured to receive the nub 411 of the agitator coupling housing 409. The divot 503 can have a depth that is less than a height of the nub 411 such that the agitator coupling housing 409 is spaced a distance above the upper surface 501 of the plate 500. In this manner, the agitator coupling housing 409 can rotate with respect to the plate 500 without friction from the plate. The upper surface 501 of the plate 500 can be configured to fit within the opening 399 of the lower portion 303 of the housing 300. The flange 505 can be configured to be positioned between an outer surface of the lower portion 303 of the housing 300 and an upper surface of the motor coupling housing (discussed below). As shown in FIG. 14 a scaling gasket 504 can be positioned on the flange and can seal the interface between the plate and the lower portion 303 of the housing.

The plate 500 can be made from a variety of rigid materials, but in an exemplary embodiment it is made of a metal having sufficient durability to withstand high pressures. Exemplary materials include stainless steel. However, the rigid plate 500 can be composed of any inert materials. The rigid plate 500 can have a maximum thickness that is less than the maximum thickness of the sidewall of the housing. The maximum thickness of the rigid plate 500 can be reduced such that the set of magnets in the agitator coupling housing can be magnetically coupled to the set of magnets in the motor assembly discussed below. The rigid plate 500 can have a thickness in the range of 1.6 mm to 2 mm, and optionally 1.8 mm. The rigid plate 500 can have a thickness that is relatively thin, e.g., about one-sixth of the thickness of the housing. The thickness of the rigid plate can be determined such that the magnetic coupling between the agitator coupling housing and the motor assembly is not adversely affected by the increase in distance between the sets of magnets due to the presence of the rigid plate. The minimum thickness of the rigid plate can be configured to withstand the high pressures that are generated in the housing, e.g., 1.6 mega pascals. For example, in an exemplary embodiment, the rigid plate 500 can be about 0.8 mm thick and be designed to withstand pressures around 3.5 MPa.

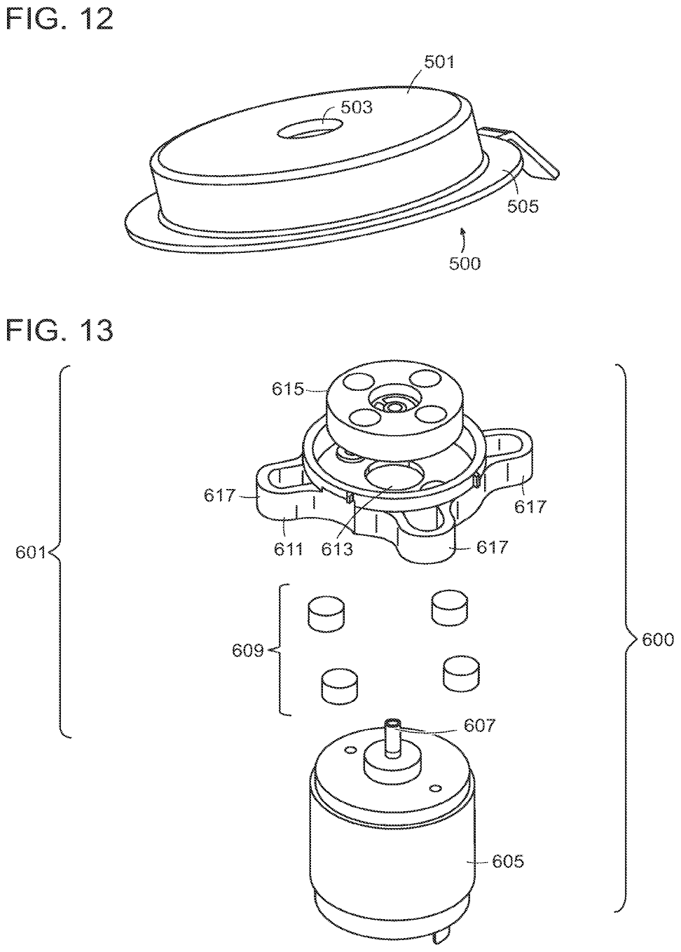

As indicated above, the carbonation mixing chamber can include a motor assembly. FIG. 13 illustrates one embodiment of a motor assembly 600. The motor assembly 600 can be disposed external to the housing 300 and can have a motor coupling housing 601 with a second set of magnets 609 disposed therein and positioned in magnetic engagement with the first set of magnets. The motor assembly 600 can also include a drive shaft 607 coupled to the motor coupling housing 601, and a motor 605 coupled to the drive shaft 607 and configured to rotate the drive shaft and the motor coupling housing 601.

The motor coupling housing 601 can be in the form of a substantially cylindrical housing. The motor coupling housing 601 can include one or more compartments for holding magnets. A second set of magnets 609 can be disposed within the motor coupling housing 601. The second set of magnets 609 can include any suitable number of magnets, for example, 2, 3, 4, 5, 6, or more magnets. In one embodiment, the second set of magnets 609 has the same number of magnets as the first set of magnets. Compartments for holding magnets can be in any suitable shape compatible with magnets. For example, the compartments can be square shaped, oval shaped, circular shaped and the like. The compartments can be spaced radially throughout the motor coupling housing. Magnets of the second set of magnets can be positioned within the motor coupling housing such that the second set of magnets are proximate the first set of magnets so as to account for the exponential drop in magnetic force with distance.

The motor coupling housing 601 can have a variety of configurations, but in the illustrated embodiment it has a cup-shaped top plate 615 that sits within a substantially circular tray 613. The top plate 615 can be configured to house the second set of magnets 609. The tray can have a central opening 613 configured to receive a drive shaft 607 attached to a motor 605. The tray can also have projecting arms 617 configured to assist in mounting the motor coupling assembly to the exterior side of the lower portion 303 of the housing 300. As best shown in FIG. 4 screws 344 can be passed through the projecting arms 617 of the tray to engage with one or more receiving holes positioned along the lower portion 303 of the housing 300. In use, the motor 605 is configured to rotate the drive shaft 607, and thereby rotate the motor coupling housing 601. Rotation of the motor coupling housing 601 results in the rotation of the second set of magnets 609. Due to the magnetic coupling between the second set of magnets 609 in the motor coupling housing 601 and the first set of magnets 419 in the agitator coupling housing 409, rotation of the second set of magnets 609 can cause corresponding rotation of the first set of magnets 419. Rotation of the first set of magnets 419 in the agitator coupling housing 409 in turn can result in the rotation of the agitator 400.

FIG. 14 is a cross-sectional diagram of the carbonation mixing chamber 200. As illustrated, the carbonation mixing chamber 200 include the housing 300 with upper and lower portions 301, 303, the agitator 400 with agitator coupling housing 409, the motor assembly 600, and the rigid plate 500.

As shown, the housing 300 includes an inner chamber 202 with a fluid inlet, a gas inlet 309, and an outlet configured to dispense a mixture of fluid and gas. The housing 300 includes the upper portion 301 with a side 326 including projections for the lower water sensor 322, the upper water sensor 315, and the gas inlets 309. Additionally, the upper portion 301 and lower portion 303 of the housing 300 mate to one another to define the inner chamber 202. The upper portion 301 and lower portion 303 are mated via screws 321 and an o-ring 328.

The agitator 400 is disposed within the housing 300. As shown, the agitator 400 includes an elongate shaft 401 with a top end 407 that engages with a housing 324 positioned along the inner surface of the upper portion 301. The elongate shaft 401 includes a middle portion 403 and has a plurality of arms 405 which extend radially outward. The agitator coupling housing 409 is connected to the terminal end of the elongate shaft 401. The agitator coupling housing 409 includes the casing 417 configured to hold the first set of magnets 419. The agitator coupling housing 409 is positioned on a bottom wall of the lower portion 303 of the housing. The agitator coupling housing 409 includes nub 411 which engages with divot 503 of rigid plate 500. As shown, a second sealing gasket or o-ring 504 can be positioned between the lower portion 303 of the housing 300 and the rigid plate 500.

The motor assembly 600 is disposed external to the housing 300 and includes motor coupling housing 601 with a second set of magnets 609 disposed therein. The first set of magnets 419 are positioned in magnetic engagement with the second set of magnets 609. The motor coupling housing 601 is coupled to a motor 305 by a drive shaft 607. The motor 305 is configured to rotate the drive shaft 607 and motor coupling housing 601 such that the second set of magnets 609 rotates to cause a corresponding rotation of the first set of magnets 419. The rotation of the first set of magnets 419 in turn rotates the agitator 400. As shown, the motor coupling housing is mounted to the lower portion 303 by screws 304.

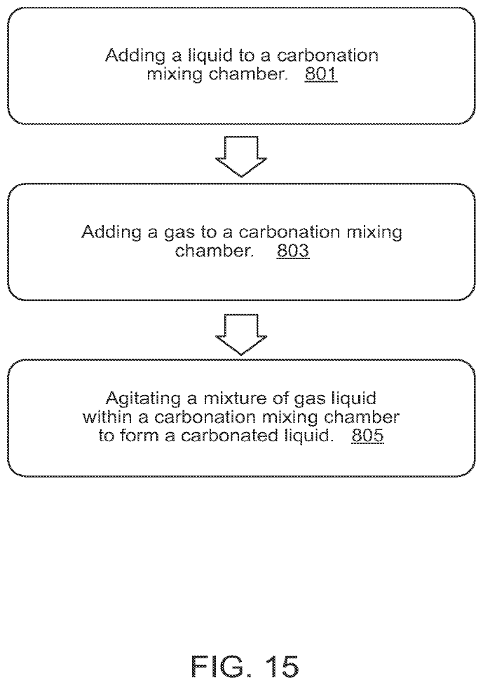

FIG. 15 illustrates a method for utilizing a carbonation mixing chamber such as carbonation mixing chamber 200. In step 801, a liquid can be added to the carbonation mixing chamber. In a second step 803, a gas can be added to the carbonation mixing chamber. In some embodiments, the liquid can be added before the gas. In some embodiments, the gas can be added to the chamber before the liquid. In some embodiments, the gas and the liquid can be added to the inner chamber simultaneously. After the liquid and gas have been added to the chamber, a motor is activated to drive rotation of the agitator in the chamber and form a carbonated fluid at step 805. The rotation of the agitator causes the gas and the liquid in the chamber to mix, as described herein, such that the gas dissolves in the liquid.

In some embodiments, the inner chamber can be filled with a liquid (e.g., water). Once the liquid reaches the first sensor, a signal can be sent to a processor. Once the liquid reaches a second top sensor, the processor can be sent a signal to stop filling the inner chamber with liquid. The processor can also be sent a signal to inject a gas (e.g., carbon dioxide). The gas can be injected until a target pressure (e.g., 0.65 MPa) is reached. Subsequently, a motor can be activated. Activation of the motor can result in the rotation of the agitator for a set amount of time (e.g., 5 seconds). Rotation of the agitator can expose the gas to as much liquid as possible as the liquid flows through the agitator structure in accordance with the systems and methods described herein.

The motor can be activated in any number of ways. For example, the motor can be activated automatically (e.g., by a microcontroller or other processor of the motor or carbonation system that includes the motor) after each of the liquid and the gas are added to the chamber. The motor can be stopped and re-started as needed to achieve the required pressure and meet the time scale as determined by a user or program. The carbonated fluid can be dispensed from the chamber to a container (e.g., a cup, a bottle, etc.) through an outlet valve in fluid communication with the chamber.

Certain illustrative implementations have been described to provide an overall understanding of the principles of the structure, function, manufacture, and use of the systems, devices, and methods disclosed herein. One or more examples of these implementations have been illustrated in the accompanying drawings. Those skilled in the art will understand that the systems, devices, and methods specifically described herein and illustrated in the accompanying drawings are non-limiting illustrative implementations and that the scope of the present invention is defined solely by the claims. The features illustrated or described in connection with one illustrative implementation can be combined with the features of other implementations. Such modifications and variations are intended to be included within the scope of the present invention. Further, in the present disclosure, like-named components of the implementations generally have similar features, and thus within a particular implementation each feature of each like-named component is not necessarily fully elaborated upon.

Approximating language, as used herein throughout the specification and claims, can be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language can correspond to the precision of an instrument for measuring the value. Here and throughout the specification and claims, range limitations can be combined and/or interchanged, such ranges are identified and include all the sub-ranges contained therein unless context or language indicates otherwise.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety.

What is claimed is:

1. A method for mixing fluid and gas, comprising:
activating a motor to rotate an outer magnetic drive housing and thereby cause corresponding rotation of an inner magnetic drive housing disposed within a mixing chamber and positioned on an opposite side of a separation plate from the outer magnetic drive housing, the mixing chamber being fluidically sealed and having a fluid and a gas disposed therein, and rotation of the inner magnetic drive housing rotating an agitator coupled thereto to thereby mix the fluid and gas.

2. The method of claim 1, wherein the agitator includes a plurality of arms extending radially outward from a central shaft, a terminal end of the central shaft being freely movably positioned within a divot formed in the separation plate.

3. The method of claim 1, wherein, prior to mixing, the gas is located above the liquid within the mixing chamber, and during rotation of the agitator the gas flows into an upper opening in an elongate shaft of the agitator and out of a lower opening of the elongate shaft of the agitator.

4. The method of claim 1, wherein the mixing chamber is disposed within a beverage dispensing system, and the method further comprises dispensing the mixed fluid and gas into a container.
